(19) United States
(12) Patent Application Publication
(10) Pub. No.: US 2002/0035188 A1
(43) Pub. Date: Mar. 21, 2002

(54) Agglomerating particulate materials

(76) Inventors: Henricus Renier Gerardus Steeghs, Littleton, CO (US); James John Schmitt, Littleton, CO (US)

Correspondence Address: Lainie E. Parker, Akzo Nobel Inc., 7 Livingstone Avenue, Dobbs Ferry, NY, 10522-3408, US

(21) Appl. No.: 09/909,067

(22) Filed: Jul. 19, 2001

Related U.S. Application Data
(60) Provisional application No. 60/219,667, filed on Jul. 21, 2000.

(51) Int. Cl. C08K 3/18; C08K 3/22

(52) U.S. Cl. 524/431; 524/424

(57) ABSTRACT

Methods for agglomerating particulate material, especially iron ore and iron ore which is difficult or impossible to bind using known binders and techniques, by rendering the surface of the material negative, by chelating interfering elements in or on the material to permit effective performance of the binder, or by using a binding effective amount of a polymeric binder, sodium carbonate, sodium citrate, and, optionally, caustic.

This application claims priority from U.S. provisional application Ser. No. 60/219,667, filed Jul. 21, 2000.

### FIELD OF THE INVENTION

The invention relates to methods for agglomerating particulate materials, a novel binder composition for agglomerating such particulate materials, and to the agglomerated products produced from such methods. The invention is particularly useful for agglomerating metallic ores such as iron ore. The inventive methods include rendering the surface of the ore negatively charged, using a combination of polymeric binder, such as carboxy methyl cellulose (CMC) and sodium citrate, or another chelating agent, and, optionally, sodium carbonate (soda ash), and agglomerating ores into pellets which are otherwise difficult or impossible to pelletize.

### BACKGROUND OF THE INVENTION

Agglomeration is commercially used in industries where materials are encountered in a form which is too finely divided for convenient processing or handling. Thus, there is a need to upgrade the size, density and/or uniformity of finely divided particles for more efficient handling, processing or recovery. Agglomeration is particularly useful in the metal refining industry, where the concentrate ore encountered is typically finely divided.

Many processes for the agglomeration of particles, especially metallic particles, are known in the art. In the mining industry it is common practice to agglomerate or pelletize finely ground mineral ore concentrate to facilitate shipping of the ore. After the mineral ore has been mined, it is frequently wet ground, though not always, and screened to remove large particles which can be recycled for further grinding. The screened mineral ore is known in the art as “concentrate”.

After screening, a binding agent is added to the wetted mineral ore concentrate and the binder/mineral ore composite is conveyed to a balling drum or other means for pelletizing the ore. The binding agent serves to hold or bind the mineral ore together until after firing. After the balling drum operation, the pellets are formed, but they are still wet. These wet pellets are commonly referred to as “green pellets” or “green balls”. These green pellets are thereafter transported to a kiln and heated in stages to an end temperature of about 2400° F.

Certain iron ore types are extremely difficult to pelletize because of an interaction (adsorption) that occurs with binders at the ore surface. Iron ores containing elements which somehow interfere with the function of the binder (interfering elements), such as sulfur (pyritite/pyrite), manganese, or other problem causing elements, or those composed largely of goethite (containing ferrous hydroxides), tend to adsorb the binder onto the ore surface, leaving the binder unavailable to absorb or control water during pelletization. With no water control, pellets form at uncontrolled rates, and the binders being used do not have the ability to disperse or hydrate properly, resulting in pellets with very poor strengths and properties.

This effect of binder adsorption is more of a problem with “organic binders” because of the inherent small addition rates being used, though bentonite performance can also be negatively effected. Bentonite is the standard “inorganic binder” being used by iron ore processors today, and is affected to a lesser extent by the problem elements listed above because of the large binder additions used.

Typically, the performance of organic and inorganic binders is enhanced by the use of salts of weak acids (such as soda ash), as in U.S. Pat. Nos. 4,288,245 and 4,597,797, or by caustic materials (such as sodium hydroxide), as in U.S. Pat. Nos. 5,698,007 and 6,071,325. Certain problematic ores, however, seem to be impervious to this technique. In non-problematic ores, the dry strength of the resulting pellets is generally about 10-12 lbs/pellet. In the problematic ores, the dry strength can decrease to about 1 lb/pellet, which results in a large amount of breakage.

### SUMMARY OF THE INVENTION

The invention is a method of agglomerating particulate materials, including particulate materials which are otherwise difficult or impossible to agglomerate. Agglomeration of the particulate materials is accomplished by rendering the surface thereof negative. Further, agglomeration is also effected by using a binder composition of a polymeric binder, sodium citrate or a chelating agent, and, optionally, sodium carbonate.

### DETAILED DESCRIPTION OF THE INVENTION

The present invention generally relates to methods of agglomerating particulate materials, especially metal containing ores. The methods include mixing the particulate material with a binder composition including a binding effective amount of a polymer, such as carboxymethyl cellulose (CMC), and a binder enhancing effective amount of sodium citrate, or a chelating agent, and, optionally, sodium carbonate, to produce a mixture, and thereafter or contemporaneously forming said mixture into agglomerates. Also included is a method of agglomerating particulate material by rendering the surface of the material, such as ore, negative. Still further, the inventive methods include agglomerating ores which are otherwise difficult or impossible to form into agglomerates of sufficient strength.

The range of the percentage of elements in the binder composition varies depending on location, i.e. depending on the type of ore, since the amount of each element needs to be adjusted based on the ability of the binder composition to effectively bind the ore. By way of a non-limiting example, the polymer, such as CMC (either technical or purified), in the binder composition can range from about 0.005% to about 0.2% based on the weight of iron ore (about 0.1 lb/ton to about 4.5 lbs/ton), the soda ash, if present, can range from about 0.005% to about 0.07% based on the weight of the ore (about 0.1 lb/ton to about 1.5 lbs/ton), the caustic soda, if present, can range from about 0.005% to about 0.05% based on the weight of the ore (about 0.1 lb/ton to about 1.1 lb/ton), and the sodium citrate, or other chelating agent or element capable of rendering the surface of the ore negatively charged, can range from about 0.005% to about 0.1% based on the weight of the ore (about 0.1 lb/ton to about 2.2 lbs/ton).

By utilizing the inventive methods for agglomerating particulate materials, the resulting agglomerates have reduced fines, low abrasion, and high physical qualities, especially strength.

It has recently been found that additions of sodium citrate and other chelating agents, either directly to the iron ore or as an added component to the binder itself, can significantly improve the performance of the binder (either organic or inorganic), making it possible to successfully bind especially difficult (if not impossible) to bind ores.

It is hypothesized that sodium citrate and certain other chelating agents prevent elements in these (at best) difficult ores from interfering with or deactivating the function of the binder. The addition of these compounds, such as sodium citrate, to prevent interference with the binder's function or to re-activate the binder is a new and different use of such compounds. Further, adding caustic to the polymer binder in addition to sodium citrate results in pellets with even greater strength. The inventive use of a binder composition of a polymeric binder, soda ash and sodium citrate, with or without caustic, greatly improves the strength of agglomerate, especially of difficult or impossible to bind particulate matter.

The present invention includes a method of agglomerating particulate materials by rendering the surface thereof negative. The method uses one or more compounds which operate to render negative the surface of such particulate materials. Non-limiting examples of such compounds include sodium citrate, acrylate dispersants, other salts of mono-, multi carboxylic acids, phosphates, non-ionic, water soluble polymers, such as guar, starch, non-ionic polyacrylamides/acrylates, and non-ionic celluloses, like methyl/ethyl cellulose.

The invention also relates to a method of binding particulate materials, especially ores, which are otherwise difficult or impossible to bind. Ores which are difficult or impossible to bind are herein defined functionally as ores which cannot be bound to a resulting sufficient pellet strength using known techniques and binders. Such ores have been found to come from Venezuela, Brazil, and Canada, for example. Thus, it is also possible to define these ores using the location of their origination. Further, most if not all of these difficult (impossible) to bind ores are hematite ores as opposed to, for example, magnetite ores which are used in the examples in U.S. Pat. Nos. 4,288,245 and 4,597,797. Accordingly, it is also possible to define such ores as hematite ores.

These difficult to bind ores are thought to have interfering elements, elements which interfere with the binder's ability to effectively bind the ore. When the inventive method employs a chelating agent, it chelates the interfering elements so that they do not interfere with the function of the binder. Examples of such interfering elements include sulfur (pyritite/pyrite), manganese, or other problem causing elements, or ores composed largely of goethite (containing ferrous hydroxides). Further, some of these ores have a high silica and aluminum content where the use of bentonite actually decreases the strength of the resulting pellets. In some instances such interfering elements may be purposefully added during processing, as opposed to being naturally present in the ore. For example, limestone and dolomite might be added to iron ore fines to increase pellet strength. However, the CaO, Ca²⁺ , Mg²⁺ and MgO ions resulting from the calcination of limestone and dolomite, and the reintroduction of these materials to the pelletizing circuit by recycling, act to in interfere with the operation of the binder. The inventive method solves this problem by using a binder composition of a polymeric binder, sodium citrate and, optionally, sodium carbonate.

Non-limiting examples of the polymeric binders useful in the present invention include (1) a water-soluable natural polymer, such as guar gum or starch, (2) a modified natural polymer, such as guar derivatives (e.g. hydroxypropyl guar, carboxymethyl guar, carboxymethyl hydroxypropyl guar), modified starch (e.g. anionic starch, cationic starch), starch derivatives (e.g. dextrin), carboxymethyl starch, pregelatinized starch, alginates, pectins, and cellulose derivatives and salts thereof (e.g. hydroxyethyl cellulose, carboxymethyl cellulose, hydroxypropyl cellulose, methyl cellulose, carboxymethylhydroxyethyl cellulose, methylhydroxyethyl cellulose, carboxymethyldihydroxypropyl cellulose), and/or (3) a synthetic polymer (e.g. polyacrylamides, polyacrylates, polyethylene oxides, and, more specifically, partially hydrogenated polyacrylamides and polyacrylates and copolymers thereof). Examples of the polymeric binders also include polyethyleneoxides, xanthan gum, dairy wastes, wood related products, lignin, or mixtures thereof. Such polymers may be used alone or as combinations of two or more different polymers.

A series of commercially available binders containing sodium carboxymethyl cellulose especially useful in the present invention is marketed by Akzo Nobel Chemicals of Amersfoort, the Netherlands, under the trademark PeridurTM.

As used herein, the term “caustic” shall mean any source of hydroxide ions (OH—) including, but not limited to sodium hydroxide, potassium hydroxide, ammonium hydroxide, calcium hydroxide, barium hydroxide, magnesium hydroxide, and the like and mixtures thereof. Sodium hydroxide, commonly known as caustic soda, is preferred.

Non-limiting examples of binder enhancing compounds which act as chelating agents to prevent deactivation of the binder by any interfering elements include sodium citrate, tetra-sodium EDTA, ether sequestering agents, oxalates, etc. One or more chelating agents are used in the inventive method.

The term “agglomerated” or “agglomeration” as used in the context of the present invention shall mean the processing of finely divided materials, whether in powder, dust, chip, or other particulate form, to form pellets, granules, briquettes, and the like.

The particulate material which may be agglomerated in accordance with the present invention may be almost any finely divided material. Such materials may include metallic minerals or ore. The predominant metal component in such ore may be iron, chrome, copper, nickel, zinc, lead, uranium, barium and the like. Mixtures of the above materials or any other metal occurring in the free or molecularly combined material state as a mineral, or any combination of the above, or other metals, or metal containing ores capable of pelletization, may be agglomerated in accordance with the present invention. The present invention is particularly well adapted for the agglomeration of materials containing iron, including iron ore deposits, ore tailings, cold and hot fines from a sinter process or aqueous iron ore concentrates from natural sources or recovered from various processes. Iron ore or any of a wide variety of the following minerals may form a part of the material to be agglomerated: taconite, magnetite, hematite, limonite, goethite, siderite, franklinite, pyrite, chalcopyrite, chromite, ilmenite and the like.

The “binding effective amount of polymer” will vary depending upon numerous factors known to the skilled artisan. Such factors include, but are not limited to, the type of particulate material to be agglomerated or pelletized, the moisture content of the particulate material, particle size, the agglomeration equipment utilized, and the desired properties of the final product, e.g. dry strength (crush), drop number, pellet size and smoothness. Though not limiting, a binding effective amount of polymer will typically be in the range of between about 0.01% to 1% by weight based on the dry weight of the mixture of particulate material, polymer and binding enhancing agents (e.g., soda ash, sodium citrate, caustic, etc.). Preferably, the polymer is present in a range of between about 0.01 to 0.4% by weight, and most preferred, about 0.025%.

The binder composition of the present invention may also contain other substances, for instance, those that are formed as by-products in the preparation of the alkali metal salt of carboxymethyl cellulose, such as sodium chloride and sodium glycolate, as well as other polysaccharides or synthetic water-soluble polymers and other “inorganic salts” (for want of a better term sodium carbonate, sodium citrate, and the like are referred to as “inorganic salts” herein). Exemplary polysaccharides include, e.g., hydroxyethyl cellulose, hydroxypropyl cellulose, carboxymethylhydroxyethyl cellulose, methyl cellulose, hydroxypropyl methyl cellulose, guar, hydroxpropyl guar and sugar beet pulp, and the like. Exemplary synthetic water-soluble polymers include partially hydrated polyacrylamide, polyvinyl alcohol, styrene/maleic anhydride copolymers, and polyacrylate and copolymers thereof, etc. Exemplary inorganic salts include, e.g. the salts described by Roorda in U.S. Pat. Nos. 4,288,245 and 4,597,797 such as sodium citrate, soda ash, and the like.

The ratios of polymer, e.g. alkali metal salt of carboxymethyl cellulose, binder enhancing agents and water to particulate material, e.g. concentrated ore, are dependent on various factors including the agglomeration method used, the material to be agglomerated and the desired properties of the agglomerates to be prepared. A person of ordinary skill in the art can readily determine the specific amounts that will be most suitable for individual circumstances. Pelletization is generally carried out using the binder composition in an amount of from about 0.0044% to about 0.44%, preferably from about 0.022% to about 0.22% (by weight of the total dry mixture), of the binder composition and about 2% to about 20%, preferably about 5% to about 15%, water, by weight of the total dry mixture. In addition to the binder composition, clays such as bentonite clay may be used in pelletization. The total amount of these clays will depend on the user's objectives, but will generally be less than 0.22%. In straight bentonite circuits, additions can be as high as 2% based on the weight of the total dry mixture.

Any known method for forming dry pellets or particles can be used to prepare the agglomerates of this invention. For instance, the concentrated ore may be agglomerated into particles or agglomerates by rotating the concentrated ore powder in a drum or disc with a binder composition and water, followed by drying and firing. Agglomerates can also be formed by briquetting, nodulizing, or spray drying.

Addition of the binder composition constituents may be carried out in any manner commonly applied in the art. For instance, the binder constituents may be mixed as solid matter with the concentrated ore in a dry or liquid form or as an emulsion or dispersion. Further, they may be simultaneously, successively or alternatively added to the concentrated ore before or during the pelletizing treatment. When caustic is included in the binder composition, a preferred method includes spraying liquid caustic on moist concentrated ore resulting from the aforementioned separation process, which has all but about 10 wt % of the water removed by, e.g. rotating disc filter. At a sufficient point upstream from the agglomerating drum or disc, the polymeric binder composition is applied so that the binder components and concentrated ore are well mixed and adequately hydrated prior to being formed into green pellets. As non-limiting ranges, the water content should generally be in the range of about 4 to 30 wt % based on the weight of dry particulate matter and most preferably between about 7 and 12 wt %.

Other substances may also be optionally added to the binder composition of the present invention. For example, in iron ore pelletizing operations, small amounts of flux, e.g., limestone or dolomite may also be added to enhance mechanical properties of the pellets. The flux also helps to reduce the dust level in the indurating furnace when the pellets are fired. Olivine, serpentine, magnesium and similar minerals may be used to improve metallurgical properties of the pellets.

Drying the wet balls and firing the resultant dry balls may be carried out as one continuous or two separate steps. The important factors are that the balls must be dry prior to firing as the balls will degrade or spall if fired without first drying them. It is therefore preferred that the balls be heated slowly to a temperature of at least about 2200° F., preferably to at least about 2400° F. and then fired at that temperature. In another embodiment, they are dried at low temperatures around 400-10000 F, preferably by heating, or alternatively, under ambient conditions, and then fired at a temperature of at least about 2200° F., more preferably at about 2400° F. Firing is carried out for a sufficient period of time to bond the small particles into pellets with enough strength to enable transportation and/or further handling, generally about 15 minutes to about 3 hours.

The process of the present invention is preferably employed with concentrated iron ore. This process is also suitable for non-ferrous concentrated ores such as ores of zinc, lead, tin, nickel and chromium and oxidic materials such as silicates and quartz, and sulphidic materials. As a practical matter, this invention is intended for use in binding the concentrated ores which result from separation of the host rock from the ore removed from the ground. However, it can also be used to bind natural ores.

The pellets resulting from this process are dry, hard agglomerates having sizes that are suitable for, e.g. shipping, handling, sintering, etc. Pellets generally have an average diameter of about ¼ to about 1 inch, preferably about ½ inch. Pellet size is generally a function of the user and operator's preference, more than of binding ability of the compositions of this invention and virtually any size pellet desired by blast furnace operations and mine operations can be prepared.

The invention is further described by the following non-limiting examples. For the purpose of characterizing the agglomerates formed, use is made of the following procedure and test protocol.

Test Protocol

Wet Drop Number was determined by repeatedly dropping two groups of ten (10) pellets each from an 18 inch height to a steel plate until a crack appeared on the surface of each pellet. The number of drops required to produce a crack on the surface of each pellet was recorded. The average of all 20 pellets was taken to determine the drop number of each agglomerated mixture.

Dry Crush Strength was determined by drying twenty (20) pellets of each agglomerated mixture to measure the moisture content. The dry pellets were then individually subjected to a Chatilion Spring Compression Tester, Model LTCM (25 pound range) at a loading rate of 0.1 inch/second. The dry strength report for each agglomerate mixture is the average cracking pressure of the twenty pellets.

Plasticity modulus (PM) indicates how plastic or easily deformed pellets are by mechanical forces. Deformation (or pellet plasticity) was observed during drop tests when the pellets were dropped from a height of 18 inches onto a steel plate, causing the pellets to undesirably flatten out on one side. To quantify the severity or degree of deformation, a Chatillion Auto Test Compression Device was used. This device is an automated compression machine linked to a computer that can record and graph the change in the pellets diameter against force during compression. A slope of the line recorded by graphing the two variables (diameter vs. force) demonstrates how easily the pellets are deformed. The higher the (slope) number, the more rigid and desirable the pellet. Pellet moisture can have an impact on the PM number and, therefore, only pellets having the same approximate moisture level can be directly compared to each other.

### EXAMPLES 1 and 2

These examples, respectively, concern Venezuelan and Brazillian hematite. Both are difficult processing ores, requiring massive amounts of binders in order to obtain sufficient green pellet strengths capable of surviving processing.

In both examples, green pellets were formed in an airplane tire using standard procedures, screened to a pellet size of −0.530, +0.500 inch, and tested for the green pellet properties of wet drop, moisture, wet crush, and dry crush. Comments were also recorded for the pellet appearance, which gives an indication of the binder's ability to absorb and control moisture.

### EXAMPLE 1

Venezuelan Hematite

Venezuelan concentrate was pelletized with a system referred to herein as the PeridurTM/PerisprayTM system. Such system includes, for example, one or more organic binders such as carboxy methyl cellulose, starch, polyacrylamides or polyacrylates, partially hydrolyzed polyacrylamides or polyacrylates, acrylamide copolymers, certain acrylates, and other cellulose or starch derivatives. The PeridurTM system is disclosed in, for example, U.S. Pat. Nos. 4,288,245 and 4,597,797. The PerisprayTM system is disclosed in, for example, U.S. Pat. No. 5,698,007. As shown in Table 1:

a) when PeridurTM addition rates were increased from a starting point of 0.02%, no improvement in any of the green pellet properties was seen. Wet drops, wet crush, and dry crush strengths remained the same, and the surface of the pellets appeared wet and rough.

b) when PerisprayTM activation system rates were increased from a starting point of 0.01%, no improvements were seen in any of the green pellet properties tested, and the surface of the pellets appeared wet and rough.

It seemed that all the “typical” binders and activator systems being used were rendered ineffective by the peculiar characteristics of this ore type, and that no matter how high of an addition rate was used, no effect on green pellet properties was noticed. The PeridurTM and PerisprayTM components are believed to be consumed or adsorbed onto the ore surface and not available for water control, hydration, or dispersion throughout the pellet.

When additions of sodium citrate are added, instant and remarkable improvements are seen. Pellet strengths exceed those of even bentonite at much lower addition rates, and the surface of the pellets became very smooth and shiny (indicating the binders ability to control moisture and growth during pelletization). The sodium citrate seems to function as a “blocking agent”, preventing the PeridurTM from adsorbing on the ore surface.

TABLE 1

| | Moisture | WD* | WC** | DC*** | Comments |
|---|---|---|---|---|---|
| 0.3% bentonite | 8.49 | 8.5 | 2.76 | 17.1 | Nice surface. Dry |
| 0.3% bentonite | 8.31 | 7.25 | 3.05 | 14.54 | Nice surface. Dry |
| 0.3% bentonite | 7.98 | 5.4 | 3.39 | 15.8 | Nice surface. Dry |
| 0.2% bentonite | 7.27 | 5.2 | | 16.1 | Nice surface. Dry |
| 0.02% P330^{1,} | 8.07 | 4.1 | 3.26 | 10.4 | Poor surface, |
| 0.01% NaOH | | | | | wet, rough |
| 0.03% P330, | 8.55 | 5.1 | 3.02 | 9.48 | Poor surface, |
| 0.01% NaOH | | | | | wet, rough |
| 0.04% P330, | 9.04 | 6.3 | 2.73 | 8.59 | Poor surface, |
| 0.01% NaOH | | | | | wet, rough |
| 0.04% P330, | 8.75 | 6.9 | 2.85 | 9.53 | Poor surface, |
| 0.03% NaOH | | | | | wet, rough |
| 0.06% P330, | 8.97 | 6.7 | 3.37 | 9.68 | Poor surface, |
| 0.03% NaOH | | | | | wet, rough |
| 0.03% P330, | 8.09 | 11.5 | 3.71 | 23.45 | Very smooth, |
| 0.1% Citrate | | | | | shiny. |
| 0.03% P330, | 8.29 | 9 | 3.72 | 14.91 | Slightly rough, |
| 0.075% Citrate | | | | | wetter |
| 0.03% P330, | 8.24 | 6.4 | 3.63 | 12.95 | Poor surface, |
| 0.05% Citrate | | | | | wet, rough |
| 0.02% P300, | 8.22 | 15.3 | 3.37 | 25.2 | Very smooth, |
| 0.1% Citrate | | | | | shiny |
| 0.02% P300, | 7.92 | 7.4 | 3.19 | 18.6 | Very smooth, |
| 0.075% Citrate | | | | | shiny. |
| 0.03% P300 | 8.04 | 2.4 | | 2.2 | Poor surface, |
| | | | | lbs. | wet, rough |

¹Peridur ™ 330 (P330) and Peridur ™ 300 (P300) available from Akzo Nobel
*Wet drop strength
**Wet crush strength
***Dry crush strength

The sodium citrate also improves the performance of the inorganic binders (like bentonite). In fact, green pellet dry strengths became so high, it was impossible to measure the strength of the green pellets as the strength exceeded the capabilities of the test equipment.

### EXAMPLE 2

Brazilian Hematite

Certain Brazilian hematites also possess the same “binder deactivating or interfering” characteristics, though not to the extreme measures of the Venezuelan hematite. In this example, additions of PeridurTM and PerisprayTM to the concentrate barely increased the strength of the pellets compared to using no binder at all. Neither did additions of bentonite help the PeridurTM performance. Strengths remained low and were not considered capable of surviving the iron ore induration process successfully.

As shown in Table 2, when sodium citrate was added (this time at very low addition rates compared to the Venezuelan case, Example 1), the green pellet properties improved dramatically. Dry crush values were approximately 4 times as strong and the surface of the pellets became very smooth, again indicating the binder's ability to once again control moisture during pelletization. This further supports the theory that the citrate seems to prevent the loss of binder at the ore surface.

TABLE 2

| Perispray ™ | Peridur ™ 330 | Bentonite | Citrate | Moisture | Wet Drops | Wet Crush | Dry Crush | Comment |
|---|---|---|---|---|---|---|---|---|
| 0 | | | | 8.6 | 2.6 | 0.98 | 0.52 | Moist |
| 0 | | | | 8.34 | 2.6 | 0.99 | 0.64 | Moist |
| 0.01% | 0.04% | | | 8.27 | 2.5 | 1.01 | 0.99 | Moist |
| 0.02% | 0.04% | | | 8.34 | 2.9 | 1.09 | 1.07 | Moist |
| 0.03% | 0.04% | | | 8.18 | 2.9 | 1.1 | 1.17 | Moist |
| 0.04% | 0.04% | | | 8.33 | 2.8 | 1.06 | 1.34 | Moist |
| 0.05% | 0.04% | | | 8.33 | 2.7 | 0.98 | 1.49 | Moist |
| | | 0.05% | | 8.78 | 2.7 | 1.01 | 1.67 | Moist |
| | | 0.10% | | 8.75 | 3 | 1.15 | 1.54 | Moist |
| | 0.04% | | 0.04% | 8.18 | 2.6 | 1.11 | 4.47 | Smooth |
| | 0.04% | | 0.02% | 8.5 | 3 | 1.17 | 4.79 | Smooth |
| | 0.04% | | 0.01% | 8.22 | 3 | 1.12 | 4.69 | Smooth |

The same effect has been demonstrated with certain problematic ores from Canada and Peru.

The sodium citrate employed in Examples 1 and 2 was a tri-sodium citrate. This material is known to be a chelating agent, and may help to explain why the material supports the performance of binders so well, as it would chelate with certain sites on the ore surface acting as a “blinding agent”, preventing adsorption and the potential for the ores to deactivate the binder or interfere with its function. This could indicate that other materials, such as Tetra-sodium EDTA (another well known chelating agent), may also have applications or potential with these problematic ores. Additionally, if the tri-sodium citrate functions to render the surface of the ore negatively charged so that the binder can function properly, then other materials having such an effect, for example, acrylate dispersants, other salts of mono-, multi carboxylic acids, phosphates, etc., may also prevent the interference with or deactivation of the binders. It is further thought that for these same reasons non-ionic, water soluble polymers, such as guar, starch, non-ionic polyacrylamides/acrylates, non-ionic celluloses, like methyl/ethyl cellulose, may also solve the problem of binding difficult to bind ores.

### EXAMPLE 3

Agglomeration of an ore, which was not a difficult to bind ore, using a binder composition of 0.8 lbs/ton PeridurTM 330 plus 0.4 lbs/ton Persipray, resulted in a dry strength of 12 lbs/ton.

Agglomeration of an ore, which was difficult to bind by PeridurTM and/or PerisprayTM, using a binder composition of 0.8 lbs/ton PeridurTM 330 plus 0.4 lbs/ton Persipray resulted in a dry strength of only 1 lb/ton.

This same difficult to bind ore was agglomerated using a binder composition of 0.2 lb/ton of sodium citrate (dry) in addition to 0.8 lbs/ton PeridurTM 330 plus 0.4 lbs/ton Persipray and resulted in a desirable dry strength of 12 lbs/ton.

Further, this same difficult to bind ore was agglomerated using a binder composition of 0.2 lb/ton sodium citrate in solution, instead of sodium citrate (dry), in addition to 0.8 lbs/ton PeridurTM 330 plus 0.4 lbs/ton Persipray and resulted in a desirable dry strength of 10 lbs/ton.

Still further, this same difficult to bind ore was agglomerated using a binder composition of sodium EDTA or an ether sequestering agent in addition to 0.8 lbs/ton PeridurTM 330 plus 0.4 lbs/ton Persipray and resulted in a desirable dry strength of 10 lbs/ton.

Yet still further, this same difficult to bind ore was agglomerated using a binder composition of oxalates, dry or in solution, in addition to 0.8 lbs/ton PeridurTM 330 plus 0.4 lbs/ton Persipray and resulted in a desirable dry strength of 9 lbs/ton.

### EXAMPLE 4

As shown in Tables 3 and 4, when both sodium citrate and caustic are used with PeridurTM to agglomerate a difficult ore, in this case a northern Brazillian ore, the dry crush strength and surface quality of the resulting pellets is greatly increased.

TABLE 3

| | | | | | Wet | Plasticity | Dry | |
|---|---|---|---|---|---|---|---|---|
| P330 | Citrate | Caustic | Moisture | Wet Drop | Crush lbs | Modulus | Crush lbs | Comments* |
| 0.03% | 0.02% | | 9.5 | 3.6 | 2.26 | 0.72 | 6.6 | Smooth, 8/10 |
| 0.03% | 0.02% | | 9.14 | 3.6 | 2.22 | 0.96 | 6.18 | Smooth, 8/10 |
| 0.03% | 0.02% | | 9.49 | 4.2 | 2.46 | 0.93 | 7.8 | Smooth, 8/10 |
| 0.03% | 0.02% | 0.01% | 9 | 4.2 | 2.39 | 1.15 | 15.7 | Very smooth, 10/10 |
| 0.03% | 0.02% | 0.01% | 9.4 | 4.4 | 2.11 | 1.09 | 16 | Very smooth, 10/10 |
| 0.03% | 0.01% | 0.01% | 9.09 | 4 | 2.28 | 0.92 | 11.7 | Very smooth, 10/10 |
| 0.03% | 0.01% | 0.01% | 9.18 | 3.9 | 2.27 | 0.88 | 11.9 | Very smooth, 10/10 |
| 0.03% | | 0.01% | 9.29 | 3.5 | 2.28 | 0.9 | 5.6 | Smooth, 8/10 |
| 0.03% | | 0.01% | 8.54 | 2.8 | 2.21 | 1.16 | 7.1 | Rougher, 7/10 |

*the comments include a visual score on appearance on a scale of 1-10; 10/10 being best and 1/10 being worst.

TABLE 4

| | | | | | | Wet | Plasticity | Dry | |
|---|---|---|---|---|---|---|---|---|---|
| P330 | P230* | Citrate | Caustic | Moisture | Wet Drop | Crush lbs | Modulus | Crush lbs | Comments |
| 0.030% | | 0.01% | 0.01% | 9.5 | 5.1 | 2.35 | 0.79 | 12.3 | Very smooth, 10/10 |
| 0.030% | | 0.01% | 0.01% | 9.77 | 5.4 | 1.97 | 0.52 | 9.4 | Very smooth, moist, 10/10 |
| 0.030% | | | 0.01% | 9.29 | 3.5 | 2.28 | 0.9 | 5.6 | Smooth, 8/10 |
| 0.030% | | | 0.01% | 8.54 | 2.8 | 2.21 | 1.16 | 7.1 | Rougher, 7/10 |
| 0.030% | | | 0.01% | 9.78 | 3.2 | 1.68 | 0.43 | 4.0 | Rougher, 7/10 |
| 0.030% | | | 0.02% | 9.45 | 4.4 | 2.11 | 0.69 | 9.4 | Smooth, but a little wet 9/10 |
| 0.030% | | | 0.02% | 9.59 | 3.8 | 2.36 | 0.66 | 9.2 | Smooth, but a little wet 9/10 |
| 0.035% | | 0.01% | 0.01% | 9.58 | 5.6 | 2.07 | 0.56 | 10.5 | Very smooth, 10/10 |
| 0.035% | | | 0.02% | 9.79 | 5.9 | 2.15 | 0.42 | 10.6 | Very smooth, 10/10 |
| | 0.030% | 0.01% | 0.01% | 9.75 | 5.4 | 2.04 | 0.46 | 11.6 | Very smooth, 10/10 |
| | 0.030% | 0.01% | 0.01% | 9.45 | 4.5 | 1.9 | 0.54 | 11.1 | Very smooth, 10/10 |

*Peridur ™ 230 (P230) available from Akzo Nobel

### EXAMPLE 5

As shown in Table 5, when both sodium citrate and soda ash are used with PeridurTM to agglomerate a “normal” ore from Brazil which is not difficult to agglomerate using known techniques and binders, pellets with desirable qualities are obtained even when the amount of soda ash is decreased.

TABLE 5

| | P300 | Soda ash | Citrate | Ratio | NaOH | pH | Moisture | | Wet Crush | |
|---|---|---|---|---|---|---|---|---|---|---|
| Test | % | % | % | Soda:Citrate | % | Concentrate | % | Wet Drop | kgs | PM |
| 1 | 0.0245 | 0.0105 | | | 0.01 | 10.64 | 10.29 | 4.3 | 1.19 | 1.01 |
| 2 | 0.0245 | 0.0105 | | | 0.01 | 10.59 | 10.31 | 4.1 | 1.15 | 0.93 |
| 3 | 0.0245 | 0.0105 | | | 0.01 | 10.67 | 10.57 | 4.4 | 1.05 | 0.77 |
| 4 | 0.0245 | 0.0100 | 0.0005 | 20:1 | 0.01 | 10.69 | 10.67 | 4.3 | 1.00 | 0.70 |
| 5 | 0.0245 | 0.0084 | 0.0021 | 4:1 | 0.01 | 10.55 | 10.54 | 4.2 | 1.00 | 0.68 |
| 6 | 0.0245 | 0.0063 | 0.0042 | 1.5:1 | 0.01 | 10.47 | 10.58 | 4.0 | 0.96 | 0.62 |
| 7 | 0.0245 | 0.0042 | 0.0063 | 1:1.5 | 0.01 | 10.59 | 10.40 | 4.2 | 0.98 | 0.63 |
| 8 | 0.0245 | 0.0021 | 0.0084 | 1:4 | 0.01 | 10.51 | 10.50 | 3.8 | 0.90 | 0.59 |
| 9 | 0.0245 | 0.0005 | 0.0100 | 1:20 | 0.01 | 10.55 | 10.33 | 4.2 | 0.91 | 0.63 |

### EXAMPLE 6

Shown in Table 6 are the effects of EDTA as a chelating agent which enhances the effectiveness of the binder by chelating elements which otherwise interfere with the binder's effectiveness.

TABLE 6

| | Tetra- | Penta- | | | | |
|---|---|---|---|---|---|---|
| | sodium | sodium | Moist- | Wet drop | Wet Crush | Dry Crush |
| Per.330 | EDTA | EDTA | ture | (kgs) | (kgs) | (kgs) |
| 0.04% | — | — | 8.34 | 2.6 | 0.99 | 0.64 |
| 0.04% | — | — | 8.60 | 2.6 | 0.98 | 0.52 |
| 0.04% | 0.02% | — | 8.51 | 2.8 | 1.07 | 1.40 |
| 0.04% | — | 0.02% | 8.50 | 2.6 | 1.08 | 2.00 |

Shown in table 7 is a comparison between two difficult to bind ores and one ore which was not difficult to bind using known binders and techniques. Both ores are from Brazil.

TABLE 7

| | | Hematite ore (difficult concentrates) | | |
|---|---|---|---|---|
| Hematite ore (normal concentrate) | | | A | B |
| Fe | 66.68 | Fe | 67.34 | 65.27 |
| SiO2 | 1.03 | SiO2 | 0.76 | 1.05 |
| Al2O3 | — | Al2O3 | 0.85 | 0.91 |
| CaO | 0.61 | CaO | 0.04 | 0.71 |
| MgO | 0.22 | MgO | 0.02 | 0.27 |
| P | 0.018 | P | 0.026 | 0.026 |
| Mn | 0.121 | Mn | 0.330 | 0.324 |

The invention is further exemplified by the following claims which, however, are not intended to and do not limit the scope of the invention.

We claim:

1. A method for agglomerating particulate material comprising:
rendering the surface of the particulate material negative;
adding to the particulate material a binding effective amount of a polymeric binder; and
forming the particulate material into agglomerates.

2. The method of claim 1, wherein said polymeric binder is guar, guar derivatives, carboxymethyl guar, hydroxypropyl guar, carboxymethylhydroxypropyl guar, modified starch, starch derivatives, carboxymethyl starch, pregelatinized starch, alginates, pectins, polyacrylamides and derivatives thereof, polyacrylates and copolymers thereof, polyethyleneoxides, cellulose derivatives and salts thereof, carboxymethyl cellulose, hydroxyethyl cellulose, carboxymethylhydroxyethyl cellulose, methylhydroxyethyl cellulose, carboxymethyldihydroxypropyl cellulose, xanthan gum, dairy wastes, wood related products, lignin, or mixtures thereof.

3. The method of claim 1, wherein the step of rendering includes adding to the particulate material sodium citrate, acrylate dispersants, other salts of mono-, multi carboxylic acids, phosphates, non-ionic water soluble polymers, guar, starch, non-ionic polyacrylamides/acrylates, non-ionic celluloses, methyl/ethyl cellulose, or mixtures thereof.

4. The method of claim 1, wherein the step of rendering includes adding sodium citrate to the particulate material and the polymeric binder is an alkali metal salt of carboxymethyl cellulose.

5. The method of claim 1, wherein the particulate material is a metal containing ore.

6. The method of claim 5, wherein the metal containing ore is iron ore.

7. The method of claim 1, further comprising adding to the particulate material sodium carbonate and caustic.

8. The method of claim 7, wherein the particulate material is iron ore, the polymeric binder is sodium carboxymethyl cellulose, the binding effective amount of sodium carboxymethyl cellulose ranges from about 0.005% to about 0.2% based on the weight of iron ore ranging from about 0.1 lb/ton to about 4.5 lbs/ton, the amount of sodium carbonate ranges from about 0.005% to about 0.07% based on the weight of the iron ore ranging from about 0.1 lb/ton to about 1.5 lbs/ton, the amount of caustic ranges from about 0.005% to about 0.05% based on the weight of the iron ore ranging from about 0.1 lb/ton to about 1.1 lb/ton, the step of rendering includes adding sodium citrate to the iron ore, and the amount of sodium citrate ranges from about 0.005% to about 0.1% based on the weight of the iron ore ranging from about 0.1 lb/ton to about 2.2 lbs/ton.

9. A method for agglomerating particulate material comprising:
chelating interfering elements in or on the particulate material;
adding to the particulate material a binding effective amount of a polymeric binder; and
forming the particulate material into agglomerates.

10. The method of claim 9, wherein said polymeric binder is guar, guar derivatives, carboxymethyl guar, hydroxypropyl guar, carboxymethylhydroxypropyl guar, modified starch, starch derivatives, carboxymethyl starch, pregelatinized starch, alginates, pectins, polyacrylamides and derivatives thereof, polyacrylates and copolymers thereof, polyethyleneoxides, cellulose derivatives and salts thereof, carboxymethyl cellulose, hydroxyethyl cellulose, carboxymethylhydroxyethyl cellulose, methylhydroxyethyl cellulose, carboxymethyidihydroxypropyl cellulose, xanthan gum, dairy wastes, wood related products, lignin, or mixtures thereof.

11. The method of claim 9, wherein the step of chelating includes adding to the particulate material sodium citrate, tetra-sodium EDTA, ether sequestering agents, oxalates, or mixtures thereof.

12. The method of claim 9, wherein the step of chelating includes adding sodium citrate to the particulate material and the polymeric binder is an alkali metal salt of carboxymethyl cellulose.

13. The method of claim 9, wherein the particulate material is a metal containing ore.

14. The method of claim 13, wherein the metal containing ore is iron ore.

15. The method of claim 9, further comprising adding to the particulate material sodium carbonate and caustic.

16. The method of claim 15, wherein the particulate material is iron ore, the polymeric binder is sodium carboxymethyl cellulose, the binding effective amount of sodium carboxymethyl cellulose ranges from about 0.005% to about 0.2% based on the weight of iron ore ranging from about 0.1 lb/ton to about 4.5 lbs/ton, the amount of sodium carbonate ranges from about 0.005% to about 0.07% based on the weight of the iron ore ranging from about 0.1 lb/ton to about 1.5 lbs/ton, the amount of caustic ranges from about 0.005% to about 0.05% based on the weight of the iron ore ranging from about 0.1 lb/ton to about 1.1 lb/ton, the step of chelating includes adding sodium citrate to the iron ore, and the amount of sodium citrate ranges from about 0.005% to about 0.1% based on the weight of the iron ore ranging from about 0.1 lb/ton to about 2.2 lbs/ton.

17. The method of claim 9, wherein the interfering elements are sulfur, manganese, ferrous hydroxides, Ca²⁺ ions, Mg²⁺ ions or mixtures thereof.

18. A method for agglomerating iron ore comprising:
adding a binding effective amount of a polymeric binder and sodium citrate to an iron ore which is otherwise difficult or impossible to form into agglomerates of sufficient strength; and
forming the iron ore into agglomerates.

19. The method of claim 18, wherein said polymeric binder is guar, guar derivatives, carboxymethyl guar, hydroxypropyl guar, carboxymethylhydroxypropyl guar, modified starch, starch derivatives, carboxymethyl starch, pregelatinized starch, alginates, pectins, polyacrylamides and derivatives thereof, polyacrylates and copolymers thereof, polyethyleneoxides, cellulose derivatives and salts thereof, carboxymethyl cellulose, hydroxyethyl cellulose, carboxymethylhydroxyethyl cellulose, methylhydroxyethyl cellulose, carboxymethyidihydroxypropyl cellulose, xanthan gum, dairy wastes, wood related products, lignin, or mixtures thereof.

20. The method of claim 18, wherein the step of adding further includes adding sodium carbonate to the iron ore and the polymeric binder is an alkali metal salt of carboxymethyl cellulose.

21. The method of claim 20, wherein the step of adding further includes adding caustic to the iron ore.

22. The method of claim 21, wherein the polymeric binder is sodium carboxymethyl cellulose, the binding effective amount of sodium carboxymethyl cellulose ranges from about 0.005% to about 0.2% based on the weight of iron ore ranging from about 0.1 lb/ton to about 4.5 lbs/ton, the amount of sodium carbonate ranges from about 0.005% to about 0.07% based on the weight of the iron ore ranging from about 0.1 lb/ton to about 1.5 lbs/ton, the amount of caustic ranges from about 0.005% to about 0.05% based on the weight of the iron ore ranging from about 0.1 lb/ton to about 1.1 lb/ton, and the amount of sodium citrate ranges from about 0.005% to about 0.1% based on the weight of the iron ore ranging from about 0.1 lb/ton to about 2.2 lbs/ton.

23. The method of claim 18, wherein the iron ore is a hematite ore.

24. The method of claim 18, wherein the iron ore is from Venezuela, Brazil or Canada.

25. A method for agglomerating particulate material comprising:
adding to the particulate material a binding effective amount of a polymeric binder, sodium carbonate and sodium citrate; and
forming the particulate material into agglomerates.

26. The method of claim 25, wherein said polymeric binder is guar, guar derivatives, carboxymethyl guar, hydroxypropyl guar, carboxymethylhydroxypropyl guar, modified starch, starch derivatives, carboxymethyl starch, pregelatinized starch, alginates, pectins, polyacrylamides and derivatives thereof, polyacrylates and copolymers thereof, polyethyleneoxides, cellulose derivatives and salts thereof, carboxymethyl cellulose, hydroxyethyl cellulose, carboxymethylhydroxyethyl cellulose, methylhydroxyethyl cellulose, carboxymethyidihydroxypropyl cellulose, xanthan gum, dairy wastes, wood related products, lignin, or mixtures thereof.

27. The method of claim 25, wherein the polymeric binder is an alkali metal salt of carboxymethyl cellulose.

28. The method of claim 25, wherein the particulate material is a metal containing ore.

29. The method of claim 28, wherein the metal containing ore is iron ore.

30. The method of claim 25, further comprising adding caustic to the particulate material.

31. The method of claim 30, wherein the particulate material is iron ore, the polymeric binder is sodium carboxymethyl cellulose, the binding effective amount of sodium carboxymethyl cellulose ranges from about 0.005% to about 0.2% based on the weight of iron ore ranging from about 0.1 lb/ton to about 4.5 lbs/ton, the amount of sodium carbonate ranges from about 0.005% to about 0.07% based on the weight of the iron ore ranging from about 0.1 lb/ton to about 1.5 lbs/ton, the amount of caustic ranges from about 0.005% to about 0.05% based on the weight of the iron ore ranging from about 0.1 lb/ton to about 1.1 lb/ton, and the amount of sodium citrate ranges from about 0.005% to about 0.1% based on the weight of the iron ore ranging from about 0.1 lb/ton to about 2.2 lbs/ton.
